(19) United States
(12) Patent Application Publication
(10) Pub. No.: US 2014/0165296 A1
(43) Pub. Date: Jun. 19, 2014

(54) Composition

(71) Applicants: Fabio Costiniti, Mira (IT); Irene Bello, Mira (IT); Laura Roscioli, Mira (IT); Simone Scoizzato, Mira (IT); Luigina Simonato, Mira (IT); Ralf Wiedemann, Sao Paulo (BR)

(72) Inventors: Fabio Costiniti, Mira (IT); Irene Bello, Mira (IT); Laura Roscioli, Mira (IT); Simone Scoizzato, Mira (IT); Luigina Simonato, Mira (IT); Ralf Wiedemann, Sao Paulo (BR)

(73) Assignee: Reckitt Benckiser N.V., Hoofddorp (NL)

(21) Appl. No.: 14/126,221

(22) PCT Filed: Jun. 15, 2012
(86) PCT No.: PCT/GB2012/051387

§ 371 Date: Mar. 4, 2014

(30) Foreign Application Priority Data
Jun. 17, 2011 (GB) 1110241.5
Aug. 15, 2011 (GB) 1113959.9

(51) Int. Cl. C11D 1/00; C11D 3/30

(52) U.S. Cl. CPC C11D 1/002; C11D 3/30
USPC 8/137; 564/506; 510/338

(57) ABSTRACT

A liquid detergent composition has a thickening system which comprises triethanolamine.

This invention relates to aqueous liquid detergents, preferably for use as a laundry composition or in conjunction with a laundry detergent.

Liquid based laundry compositions have been known for many years. A major issue encountered with such compositions has been the achievement of a suitable viscosity for the liquid: the liquid has to be viscous enough so that any particles are suspended yet have a sufficiently high degree of flow for ease of manufacture and dispense by a consumer.

To achieve the desired rheology typically thickeners are used. These thickeners are rheology modifiers suitable for liquid detergents. They are used to associate a higher concentration of active ingredients and to aggregate them in a stable matrix.

Numerous thickening systems have been developed over the years but there is still room for improvement in such systems, particularly as regards cost effectiveness and environmental concerns.

Different kinds of thickener are commercially available. One class of thickener that is used extensively are those based upon polymeric-carboxylic acids and their salts.

Whilst generally these thickeners are highly effective one significant disadvantage in their use is that their efficacy is highly dependent on the pH and ionic strength of the liquid in which they are employed.

Indeed the thickening effect of carboxylic acid based thickeners is only significant in alkaline solutions and/or solution having low ionic strength when the carboxylic acid based thickeners are in a dissociate state.

In such a condition the thickening mechanism is based on 2 main effects:

In an alkaline environment the carboxylic acid dissociates to carboxylate anions. As a result the electrostatic repulsion of the anions causes the stretching of the polymer chain. This phenomenon reduces the degrees of freedom of the structure in the liquid matrix.

Moreover the carboxylate anions interact with the hydrophilic heads of the surfactant micelles, creating a tri-dimensional network between the thickener backbone and the micelles (associative effect).

The result of these two effects in the right conditions is the increase of viscosity of the liquid.

It is therefore a primary object of this invention to develop stabilised laundry detergent composition (or a composition to be used in conjunction with a laundry detergent) which incorporates a low cost, but effective, thickening system over a broad range of conditions.

According to the first aspect of the present invention there is provided a liquid detergent composition having a thickening system which comprises triethanolamine.

Preferably the thickening system further comprises a LAS (linear alkylbenzene sulphonate) surfactant.

With the thickening system of the present invention it has been found that superior thickening of a liquid detergent composition can be achieved. Without wishing to be limited by theory it is postulated that the superior thickening is brought about by generation of a LAS-TEA salt, which gives rise to the formation of micelles, and high viscosity.

Preferably the triethanolamine is present in an amount of up to 10 wt %, more preferably from 0.1 to 5 wt %, more preferably from 1 to 4 wt % and most preferably from 1.4 to 3 wt %.

Preferably the composition comprises from 0.001% to 99.99%, preferably 0.001% to 20%, preferably 4% to 18%, e.g. most preferably about 4.5% or 13%, by weight, of bleach. The bleach is preferably peroxide bleach, most preferably hydrogen peroxide. Peroxide sources other than H₂O₂ can be used.

Preferably the composition comprises a surfactant. Where present the composition comprises from 0.001% to 99.99%, preferably 0.05% to 40%, preferably 10% to 30%, e.g. about 25%, by weight of surfactant.

The surfactant is, for example, an anionic or nonionic surfactant or mixture thereof (most preferably a non-ionic surfactant). The nonionic surfactant is preferably a surfactant having a formula RO(CH₂CH₂O) ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol trade name from Shell Co.), such as C₁₁ alkanol condensed with 9 moles of ethylene oxide (Neodol 1-9), C₁₂₋₁₃ alkanol condensed with 6.5 moles ethylene oxide (Neodol 23-6.5), C₁₂₋₁₃ alkanol with 9 moles of ethylene oxide (Neodol 23-9), C12-15 alkanol condensed with 7 or 3 moles ethylene oxide (Neodol 25-7 or Neodol 25-3), C₁₄₋₁₅ alkanol condensed with 13 moles ethylene oxide (Neodol 45-13), C₉₋₁₁ linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention.

Other examples of linear primary alcohol ethoxylates are available under the Tomadol trade name such as, for example, Tomadol 1-7, a C₁₁ linear primary alcohol ethoxylate with 7 moles EO; Tomadol 25-7, a C₁₂-C₁₅ linear primary alcohol ethoxylate with 7 moles EO; Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other examples of linear primary alcohol ethoxylates are available under the Lutensol trade name such as, for example, Lutensol A3N, a C₁₃₋₁₅ linear primary alcohol ethoxylate with 3 moles EO; Lutensol LA60, a C₁₃₋₁₅ linear primary alcohol ethoxylate with 7 moles EO. Also Genapol such as, for example, Genapol LA3, a C₁₃₋₁₅ linear primary alcohol ethoxylate with 3 moles EO; Genapol LA070, a C₁₃₋₁₅ linear primary alcohol ethoxylate with 7 moles EO

Tomadol 45-7,a C₁₄-C₁₅ linear primary alcohol ethoxylate with 7 moles EO; and Tomadol 91-6, a C₉-C₁₁ linear alcohol ethoxylate with 6 moles EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and acyl/oleoyl sarcosinates and mixtures thereof.

The composition may various optional ingredients, including enzymes, builders, solvents, dye transfer inhibition agents, dye catchers, preservatives, antioxidants, anti-static agents, fragrances, odour absorbing components, optical brighteners, acidifying agents, alkalizing agents, thickeners (e.g. hydroxyethylcellulose and/or xanthan gum).

The pH range of the fabric treatment composition is typically from about 1 to about 8, e.g. from 3 to 5, more preferably from 3.6-4.3.

The composition is preferably used in a washing machine cycle and/or as a pre-soaker/soaker in a clothes cleaning operation, e.g. as a fabric treatment composition.

The invention will be illustrated with reference to the following non-limiting Examples.

### EXAMPLES

A base formulation was prepared having the formulation below.

| Raw materials | wt % |
|---|---|
| Water | 59.6 |
| NaOH 50% | 1.4 |
| Thickener | See Below |
| Surfactant - Anionic (LAS) | 10.0 |
| Surfactant - Non Ionic | 17.0 |
| Bleach Agent 50% | 16.0 |
| Minors | 1.3 |

| Thickener | Viscosity (cps) |
|---|---|
| Base as above no thickener | 700 |
| Base + 1.5 wt % TEA | 1300 |
| Base + 2.7 wt % TEA | 2000 |
| Base + 0.5 wt % polyacrylate | 1900 |
| Base + 0.5 wt % polyacrylate ++ 2.4 wt % TEA | 2200 |

Viscosity was measured using an AR 550 rheometer from TA instruments using a plate steel spindle at 40 mm diameter and a gap size of 500 micrometres.

1. A liquid detergent composition having a thickening system which thickening system comprises triethanolamine

2. A liquid detergent composition according to claim 1, wherein the thickening system comprises triethanolamine and (linear alkylbenzene sulphonate) surfactant.

3. A composition according to claim 1, wherein the triethanolamine is present in the liquid detergent composition in an amount of 0.1 to 5wt %.

4. A process for treating fabric, the process comprising the step of: contacting the fabric during a laundry washing/fabric treatment operation with a liquid detergent composition according to claim 1.

5. A process according to claim 4, wherein the liquid detergent composition contains a thickening system which comprises triethanolamine and a linear alkyl benzene sulfonate surfactant.

6. A liquid detergent composition according to claim 1, wherein the composition further comprises bleach.

7. A liquid detergent composition according to claim 1, the composition having a pH of from 1 to 8.

8. A liquid detergent composition according to claim 6, the composition having a pH of from 1 to 8.

9. A method of thickening an aqueous laundry detergent composition, which method comprises the steps of:
generating as a thickening system within the composition a triethanolamine salt of a linear alkylbenzene sulfonate.

10. A method according to claim 9, wherein the generation of the thickening system occurs wherein the aqueous laundry detergent composition is at an alkaline pH.
